(19) United States
(12) Patent Application Publication
(10) Pub. No.: US 2026/0030351 A1
(43) Pub. Date: Jan. 29, 2026

(54) THREAT ANALYSIS SYSTEM AND THREAT ANALYSIS METHOD

(71) Applicant: Panasonic Automotive Systems Co., Ltd., Kanagawa (JP)

(72) Inventors: Takumaru NAGAI, Osaka (JP); Takashi TOKIZAKI, Kanagawa (JP); Takahiro YONEDA, Osaka (JP)

(73) Assignee: Panasonic Automotive Systems Co., Ltd., Kanagawa (JP)

(21) Appl. No.: 19/264,390

(22) Filed: Jul. 9, 2025

(30) Foreign Application Priority Data
Jul. 24, 2024 (JP) 2024-118957

(51) Int. Cl. G06F 21/55; G06F 21/56; G06F 21/57

(52) U.S. Cl. CPC G06F 21/554; G06F 21/562; G06F 21/577

(57) ABSTRACT

A threat analysis system analyzes a security threat to an analysis target system and includes: an input unit that obtains design information on design of the analysis target system; an analyzer that analyzes a threat to the analysis target system based on design information to output first analysis result information indicating: an asset handled by the analysis target system; a threat to the asset; and a management countermeasure against the threat to the asset; a countermeasure processor that generates second analysis result information including the first analysis result information and one or more concrete countermeasures that are concretized from the management countermeasure and each associated with a corresponding functional layer included in the analysis target system by combining the first analysis result information and the one or more concrete countermeasures; and an output unit that outputs the second analysis result information.

### CROSS REFERENCE TO RELATED APPLICATION

The present application is based on and claims priority of Japanese Patent Application No. 2024-118957 filed on Jul. 24, 2024.

### FIELD

The present disclosure relates to a threat analysis system or the like that analyzes a security threat to an analysis target system.

### BACKGROUND

For example, Patent Literature (PTL) 1 discloses a threat analysis system. This threat analysis system obtains design information on an analysis target system and analyzes, based on the obtained design information, an asset attack feasibility and an impact of the asset attack for each component and each function of the analysis target system. Note that an asset is data handled by the analysis target system, for example.

### CITATION LIST

### Patent Literature

PTL 1: Japanese Unexamined Patent Application Publication No. 2023-47569

### SUMMARY

Unfortunately, the threat analysis system disclosed in PTL 1 described above can be improved upon.

In response to this, the present disclosure provides a threat analysis system or the like that is capable of improving upon the above related art.

According to an aspect of the present disclosure, a threat analysis system that analyzes a security threat to an analysis target system includes: an input unit that obtains design information on design of the analysis target system; an analyzer that analyzes a threat to the analysis target system based on the design information to output first analysis result information, the first analysis result information indicating: an asset handled by the analysis target system; a threat to the asset; and a management countermeasure that is a countermeasure against the threat to the asset; a countermeasure processor that generates second analysis result information including the first analysis result information and one or more concrete countermeasures by combining the one or more concrete countermeasures with the first analysis result information, the one or more concrete countermeasures being concretized from the management countermeasure indicated in the first analysis result information, the one or more concrete countermeasures each being associated with a corresponding one of one or more functional layers included in the analysis target system; and an output unit that outputs the second analysis result information.

General or specific aspects of the present disclosure may be implemented to a device, a method, an integrated circuit, a computer program, a computer-readable recording medium such as a Compact Disc-Read Only Memory (CD-ROM), or any given combination thereof. The recording medium may be a non-transitory recording medium.

The threat analysis system according to the present disclosure is capable of improving upon the above related art.

It should be noted that further advantages and effects of the aspect of the present disclosure are apparent from the Description and the Drawings. Such advantages and/or effects are produced by the constituent elements disclosed in the embodiment and the Description and the Drawings. However, all of the constituent elements are not necessarily to produce the advantages and/or effects.

### BRIEF DESCRIPTION OF DRAWINGS

FIG. 1 is a block diagram illustrating a configuration of a threat analysis system that is conventionally conceivable.

FIG. 2 is a diagram illustrating an example of analysis result information outputted from the threat analysis system that is conventionally conceivable.

FIG. 3 is a diagram illustrating an example of a configuration of a threat analysis system according to Embodiment.

FIG. 4 is a diagram illustrating functional layer information according to Embodiment.

FIG. 5 is a diagram illustrating an example of a concrete countermeasure database according to Embodiment.

FIG. 6 is a diagram illustrating an example of part of second analysis result information according to Embodiment.

FIG. 7 is a diagram illustrating an example of different part of the second analysis result information according to Embodiment.

FIG. 8 is a flowchart illustrating an example of a processing operation performed by the threat analysis system according to Embodiment.

FIG. 9 is a flowchart illustrating an example of a specific processing operation of countermeasure processing performed by the threat analysis system according to Embodiment.

FIG. 10 is a diagram illustrating an example of first analysis result information that includes a plurality of sets of line information, according to Embodiment.

FIG. 11 is a diagram illustrating an example of asset input-output information according to Embodiment.

FIG. 12 is a diagram illustrating an example of part relating to line information included in the second analysis result information according to Embodiment.

FIG. 13 is a diagram illustrating an example of part relating to another set of line information included in the second analysis result information according to Embodiment.

FIG. 14 is a diagram illustrating an example of part relating to still another set of line information included in the second analysis result information according to Embodiment.

FIG. 15 is a diagram illustrating an example of the second analysis result information after an edit, according Embodiment.

### DESCRIPTION OF EMBODIMENTS

### Underlying Knowledge Forming Basis of the Present Disclosure

In relation to the threat analysis system disclosed in PTL 1 described in the Background section, the inventors have found the following issue.

In recent years, a number of devices included in a vehicle are communicatively connected via a controller area network (CAN) or Ethernet (registered trademark), for example. Through the spread of connected cars, these devices may communicate with an external device of the vehicle. In addition, such a communication has diversified. With the progress of connected, autonomous, smart/shared & services, and electric (CASE) vehicles, an analysis target system that includes the aforementioned devices requires analysis of threats to this analysis target system and analysis or management of security risks to this analysis target system at an early stage of the development life cycle of the analysis target system.

The threat analysis system according to PTL 1 analyzes the feasibility of an attack on an asset handled by the analysis target system and also analyzes the impact of the attack on the asset. However, the countermeasure against the threat that is presented or indicated through the analysis by the threat analysis system according to PTL 1 is too abstract, as is the case with a following threat analysis system that is conventionally conceivable. In other words, the threat analysis system disclosed in PTL 1 described above has a problem that an appropriate countermeasure against a threat is not presented.

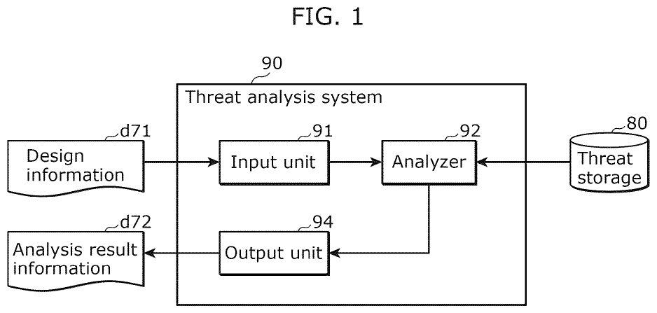

FIG. 1 is a block diagram illustrating a configuration of the threat analysis system that is conventionally conceivable.

Threat analysis system 90 that is conventionally conceivable analyzes a cybersecurity threat to, for example, an analysis target system included in a vehicle. Threat analysis system 90 includes input unit 91, analyzer 92, and output unit 94.

Input unit 91 obtains design information d71 on the analysis target system, based on an input operation performed by a user, for example. Analyzer 92 obtains design information d71 from input unit 91, and analyzes the aforementioned threat to the analysis target system based on design information d71. In this case, analyzer 92 performs the analysis with reference to a threat database stored in threat storage 80. Analyzer 92 generates analysis result information d72 as a result of the analysis. Output unit 94 outputs analysis result information d72 generated by analyzer 92 to, for example, a display.

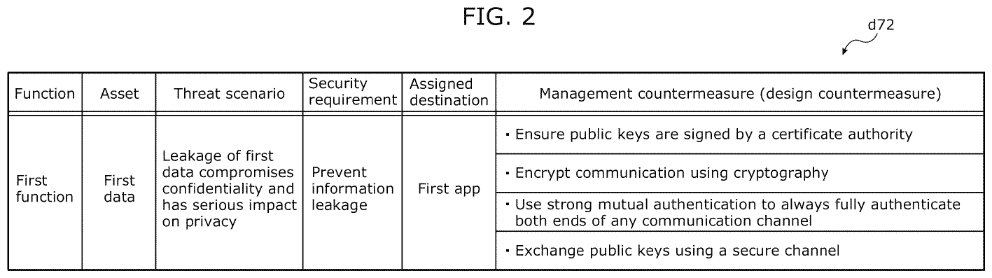

FIG. 2 is a diagram illustrating an example of analysis result information d72 outputted from threat analysis system 90. Analysis result information d72 shows an association among a function, an asset, a threat scenario, a security requirement, an assigned destination, and management countermeasures. The asset is, for example, data handled by threat analysis system 90. The function uses this asset. The threat scenario is a scenario of a threat to the asset. The security requirement is a requirement to prevent this threat scenario from occurring. The assigned destination is a component having the aforementioned function, among a plurality of components included in the analysis target system. The management countermeasures are against the aforementioned threat and implemented to satisfy the security requirement.

Such a management countermeasure is too abstract. Thus, even when the management countermeasure is presented, any development person for the analysis target system cannot easily pinpoint a functional layer this management countermeasure applies to. In addition, it is difficult for any development person to immediately take the countermeasure against the threat.

According to an aspect of the present disclosure, a threat analysis system that analyzes a security threat to an analysis target system includes: an input unit that obtains design information on design of the analysis target system; an analyzer that analyzes a threat to the analysis target system based on the design information to output first analysis result information, the first analysis result information indicating: an asset handled by the analysis target system; a threat to the asset; and a management countermeasure that is a countermeasure against the threat to the asset; a countermeasure processor that generates second analysis result information including the first analysis result information and one or more concrete countermeasures by combining the one or more concrete countermeasures with the first analysis result information, the one or more concrete countermeasures being concretized from the management countermeasure indicated in the first analysis result information, the one or more concrete countermeasures each being associated with a corresponding one of one or more functional layers included in the analysis target system; and an output unit that outputs the second analysis result information. Examples of the asset include data. Examples of the functional layer include a hardware layer, an Operating System (OS) layer, a middleware layer, and an app layer (namely, application program layer).

In this way, the second analysis result information including the first analysis result information and the concrete countermeasure is outputted. Specifically, not only the management countermeasure but also the concrete countermeasure that is concretized from this management countermeasure and that is associated with the corresponding one of the one or more functional layers is outputted and displayed on, for example, a display. This allows, for example, a development person responsible for the functional layer to easily identify the concrete countermeasure associated with the functional layer this development person is responsible for, among the concrete countermeasures against the threat to the analysis target system. According to a first aspect of the present disclosure, an appropriate countermeasure against the threat can be presented. This allows the development person responsible for the functional layer to appropriately perform the concrete countermeasure on the component belonging to this functional layer in the analysis target system. Thus, even when the development person is not a security person, the development person can easily understand the concrete countermeasure and immediately execute this concrete countermeasure. Therefore, the threat analysis system according to the first aspect is capable of presenting an appropriate countermeasure against a threat. This increases the efficiency of security activities and enhances the quality of security.

According to a second aspect of the present disclosure, it is possible in the threat analysis system that, when the countermeasure processor combines the one or more concrete countermeasures with the first analysis result information, the countermeasure processor: determines, with reference to a concrete countermeasure database, the one or more concrete countermeasures each of which is associated with the management countermeasure indicated in the first analysis result information and associated with the corresponding one of the one or more functional layers, the concrete countermeasure database indicating, for each of a plurality of management countermeasures, a concrete countermeasure for each of functional layers; and combines the one or more concrete countermeasures determined in the determining with the first analysis result information. Note that the second aspect may depend from the first aspect.

The concrete countermeasure database stores beforehand, for each of the plurality of management countermeasures, the concrete countermeasure for each functional layer. Thus, with reference to this concrete countermeasure database, an appropriate concrete countermeasure can be determined and combined with the first analysis result information.

According to a third aspect of the present disclosure, it is possible in the threat analysis system that the design information indicates, for each of a plurality of components included in the analysis target system, a functional layer to which the component belongs, and when the countermeasure processor combines the one or more concrete countermeasures with the first analysis result information, the countermeasure processor determines, from among a plurality of functional layers indicated in the design information, the one or more functional layers to which one or more components relating to the asset belongs, with reference to the design information, the plurality of functional layers each being the functional layer. Examples of the design information include functional layer information that indicates a functional layer to which each of the components belongs. Note that the third aspect may depend from the first or second aspect.

The design information includes beforehand the functional layer for each of the plurality of components. Thus, with reference to this design information (or more specifically, the functional layer information), an appropriate functional layer can be determined. This prevent a functional layer of a component unrelated to the asset handled by the analysis target system from being determined. Thus, only the required concrete countermeasure associated with the functional layer can be presented.

According to a fourth aspect of the present disclosure, it is possible in the threat analysis system that the design information further indicates a data flow of input and output of the asset between the plurality of components, and when the countermeasure processor combines the one or more concrete countermeasures with the first analysis result information, the countermeasure processor determines, from among the plurality of components, one or more components in the data flow as the one or more components relating to the asset, with reference to the data flow indicated by the design information. Examples of the design information include asset input-output information that indicates a data flow showing input and output of asset between the plurality of components. Note that the fourth aspect may depend from the third aspect.

This enables an appropriate determination of the one or more components relating to the asset.

According to a fifth aspect of the present disclosure, it is possible in the threat analysis system that when the countermeasure processor combines the one or more concrete countermeasures with the first analysis result information, the countermeasure processor selects one component as a processing target component from among the one or more components in the data flow, in a reverse order of the data flow, and each time the countermeasure processor selects the processing target component, the countermeasure processor determines, with reference to the concrete countermeasure database, a concrete countermeasure among the one or more concrete countermeasures, the concrete countermeasure being associated with the management countermeasure indicated in the first analysis result information and being associated with a functional layer corresponding to the processing target component among the one or more functional layers. Note that the fifth aspect may depend from the fourth aspect.

In this way, the one or more components relating to the asset are determined in an appropriate order and the concrete countermeasures for the components in the data flow are determined in this appropriate order.

According to a sixth aspect of the present disclosure, it is possible in the threat analysis system that when the output unit outputs the second analysis result information, the output unit outputs, for each component included in the analysis target system, at least one concrete countermeasure among the one or more concrete countermeasures, the at least one concrete countermeasure being indicated in the second analysis result information and being associated with a functional layer corresponding to the component among the one or more functional layers, and when the at least one concrete countermeasure is a plurality of concrete countermeasures, and the plurality of concrete countermeasures include identical concrete countermeasures, the output unit outputs only one concrete countermeasure as a unified concrete countermeasure from among the identical concrete countermeasures. Note that the sixth aspect may depend from any one of the first to fifth aspects. For example, the output unit displays the concrete countermeasure, the unified concrete countermeasure, and the like by outputting them to a display.

In this way, for each component, the one or more concrete countermeasures associated with the functional layer of the component are outputted (e.g., displayed). This allows the development person responsible for the functional layer can easily identify the one or more concrete countermeasures required for the component belonging to this functional layer. Moreover, only one of the plurality of identical concrete countermeasures is outputted (e.g., displayed) as the unified concrete countermeasure. In other words, the plurality of identical concrete countermeasures are unified into one concrete countermeasure. This can reduce the number of concrete countermeasures to be displayed. Thus, the development person can reduce a burden of checking concrete countermeasures to be executed by this development person, and thus can easily identify the concrete countermeasure. Note that an output destination of the concrete countermeasures and the unified concrete countermeasure outputted by the output unit is not limited to the display. The output destination may be a different device, such as a recording medium.

According to a seventh aspect of the present disclosure, it is possible in the threat analysis system that when the identical concrete countermeasures are associated with respective different assets, the output unit outputs information indicating the respective different assets in association with the unified concrete countermeasure. Note that the seventh aspect may depend from the sixth aspect.

In this way, even when the plurality of identical concrete countermeasures are unified into one concrete countermeasure, this unified concrete countermeasure is outputted (e.g., displayed) in association with the information indicating the different assets. This allows the development person to easily identify the association between this unified concrete countermeasure and the assets.

According to an eighth aspect of the present disclosure, a threat analysis method to be executed by a computer to analyze a security threat to an analysis target system includes: obtaining design information on design of the analysis target system; analyzing a threat to the analysis target system based on the design information to output first analysis result information, the first analysis result information indicating: an asset handled by the analysis target system; a threat to the asset; and a management countermeasure that is a countermeasure against the threat to the asset; generating second analysis result information including the first analysis result information and one or more concrete countermeasures by combining the one or more concrete countermeasures with the first analysis result information, the one or more concrete countermeasures being concretized from the management countermeasure indicated in the first analysis result information, the one or more concrete countermeasures each being associated with a corresponding one of one or more functional layers included in the analysis target system; and outputting the second analysis result information.

With this, it is possible to produce the same advantageous effects as the thread analysis system according to the first aspect.

Hereinafter, certain exemplary embodiments will be described in detail with reference to the accompanying Drawings. The following embodiments are general or specific examples of the present disclosure. The numerical values, shapes, materials, constituent elements, arrangement and connection configuration of the elements, steps, the order of the steps, etc., described in the following embodiments are merely examples, and are not intended to limit the present disclosure.

Among elements in the following embodiments, those not described in any one of the independent claims indicating the broadest concept of the present disclosure are described as optional elements.

Note that the respective figures are schematic diagrams and are not necessarily precise illustrations. Additionally, components that are essentially the same share like reference signs in the figures.

### EMBODIMENT

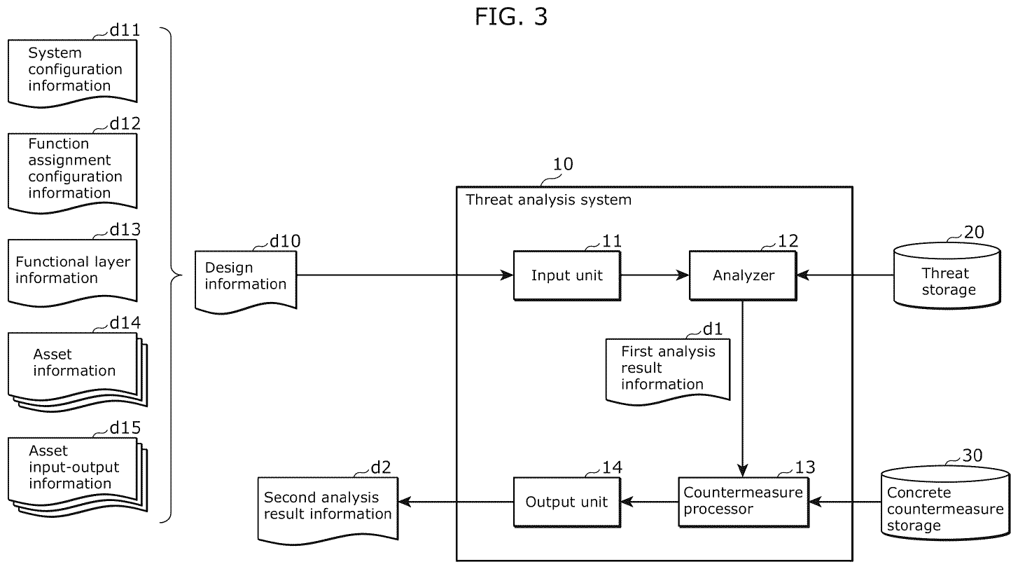

FIG. 3 is a diagram illustrating an example of a configuration of a threat analysis system according to the present embodiment.

Threat analysis system 10 according to the present embodiment analyzes a security threat to an analysis target system. Threat analysis system 10 includes input unit 11, analyzer 12, countermeasure processor 13, and output unit 14. Note that security refers to cybersecurity, for example.

Input unit 11 obtains design information d10 on the analysis target system, based on an input operation performed by a user, for example. Design information d10 is information on design of the analysis target system, and includes system information d11, configuration function assignment configuration information d12, functional layer information d13, asset information d14, and asset input-output information d15.

System configuration information d11 indicates: a plurality of components (also referred to as constituent elements) included in the analysis target system; a connection relationship between the plurality of components; and a connection relationship between the analysis target system and an external device. Note that the plurality of components include a central processing unit (CPU), a memory, a network interface (network IF), an operating system (OS), and an application (app). Note that the app refers to an application program. Moreover, examples of the component may include an electronic control unit (ECU).

Function assignment configuration information d12 indicates: a plurality of functions of the analysis target system; and components each of which has a different one of the plurality of functions.

Functional layer information d13 indicates a functional layer to which a corresponding one of the plurality of components included in the analysis target system belongs. Examples of the functional layer include a hardware layer, an OS layer, a middleware layer, and an app layer.

Asset information d14 indicates an asset used by a corresponding function of the analysis target system. The asset is data, for example. Asset information d14 may indicate the characteristics based on the confidentiality, integrity, and availability (CIA) triad and a breach impact evaluation, for example.

Asset input-output information d15 indicates, for each asset, a data flow showing input and output of the asset between the plurality of components included in the analysis target system.

Analyzer 12 obtains design information d10 from input unit 11 and analyzes the aforementioned threat to the analysis target system based on design information d10. In this case, analyzer 12 performs the analysis with reference to a threat database stored in threat storage 20. Note that the threat database stored in threat storage 20 may be identical to the threat database stored in threat storage 80 illustrated in FIG. 1. Threat storage 20 is a recording medium for storing the threat database. For example, threat storage 20 is a hard disk drive, a random access memory (RAM), a read only memory (ROM), or a semiconductor memory. Furthermore, threat storage 20 may be volatile or nonvolatile.

As a result of the analysis described above, analyzer 12 generates and outputs first analysis result information d1. First analysis result information d1 indicates an asset handled by the analysis target system, a threat to the asset, and a management countermeasure that is a countermeasure against the threat. First analysis result information d1 may show the same content as analysis result information d72 illustrated in FIG. 1 and FIG. 2. Note that first analysis result information d1 indicates the aforementioned threat as a threat scenario.

Analyzer 12 according to the present embodiment generates and outputs first analysis result information d1 by analyzing, based on design information d10, the threat to the analysis target system.

Countermeasure processor 13 obtains first analysis result information d1 from analyzer 12. Then, countermeasure processor 13 generates second analysis result information d2 by combining a concrete countermeasure indicated in a concrete countermeasure database stored in concrete countermeasure storage 30 with first analysis result information d1. Note that concrete countermeasure storage 30 is a recording medium for storing the concrete countermeasure database. For example, concrete countermeasure storage 30 is a hard disk drive, a RAM, a ROM, or a semiconductor memory, as with threat storage 20. Note that concrete countermeasure storage 30 may be volatile or nonvolatile.

Specifically, countermeasure processor 13 according to the present embodiment combines a concrete countermeasure with first analysis result information d1. The concrete countermeasure is concretized from a management countermeasure indicated in first analysis result information d1, and is provided for each of one or more functional layers included in the analysis target system. As a result of this, countermeasure processor 13 generates second analysis result information d2 that includes first analysis result information d1 and the concrete countermeasure.

Output unit 14 outputs second analysis result information d2 generated by countermeasure processor 13 to, for example, a display.

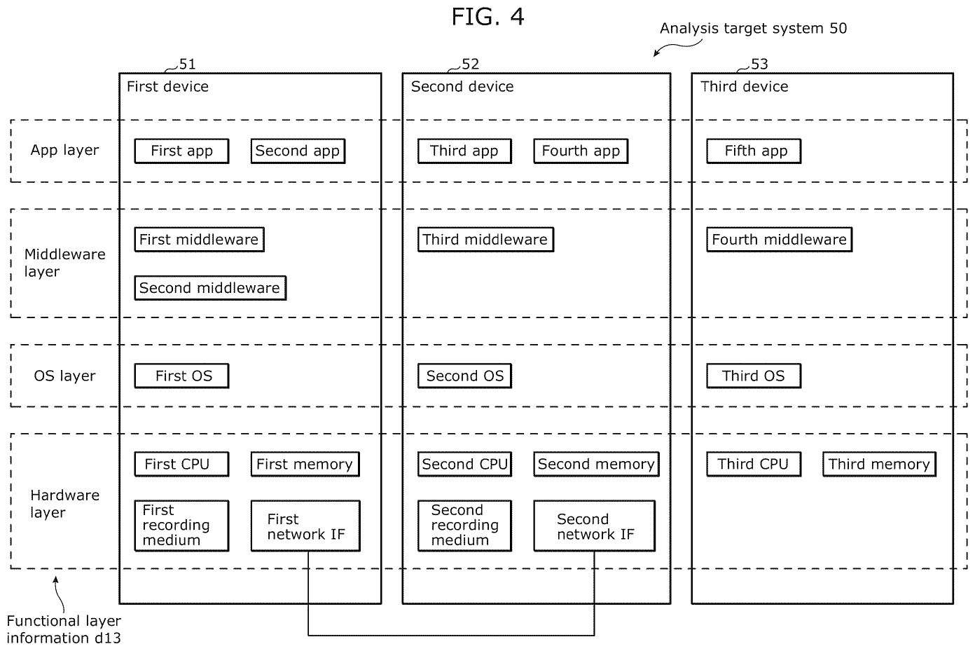

FIG. 4 is a diagram illustrating functional layer information d13 according to the present embodiment.

Functional layer information d13 indicates a functional layer for each component included in analysis target system 50, as illustrated by example in FIG. 4. To be more specific, analysis target system 50 includes first device 51, second device 52, and third device 53. For analysis target system 50 that is an in-vehicle system, first device 51, second device 52, and third device 53 may be ECUs. Each of first device 51, second device 52, and third device 53 may be a server device or a terminal device, for example. The terminal device may be a personal computer, a tablet, or a smartphone, for example.

First device 51 includes a first CPU, a first memory, a first recording medium, a first network IF, a first OS, a first middleware, a second middleware, a first app, and a second app as components, for example.

Second device 52 includes a second CPU, a second memory, a second recording medium, a second network IF, a second OS, a third middleware, a third app, and a fourth app as components, for example.

Third device 53 includes a third CPU, a third memory, a third OS, a fourth middleware, and a fifth app as components, for example.

Functional layer information d13 indicates, for each of the aforementioned devices, the functional layers to which the components of the device belong. For example, functional layer information d13 indicates the hardware layer as a functional layer to which the first CPU, the second CPU, the third CPU, the first memory, the second memory, the third memory, the first recording medium, the second recording medium, the first network IF, and the second network IF belong. Furthermore, functional layer information d13 indicates the OS layer as a functional layer to which the first OS, the second OS, and the third OS belong. Furthermore, functional layer information d13 indicates the middleware layer as a functional layer to which the first middleware, the second middleware, the third middleware, and the fourth middleware belong. Furthermore, functional layer information d13 indicates the app layer as a functional layer to which the first app, the second app, the third app, the fourth app, and the fifth app belong.

Note that system configuration information d11 may indicate types, manufacturers, and model numbers of these components. Moreover, system configuration information d11 may indicate a connection relationship between the components. For example, system configuration information d11 may indicate a connection relationship between the first network IF and the second network IF. This connection relationship may include types, versions, protocols, cryptographic schemes, and cryptographic key lengths of the networks.

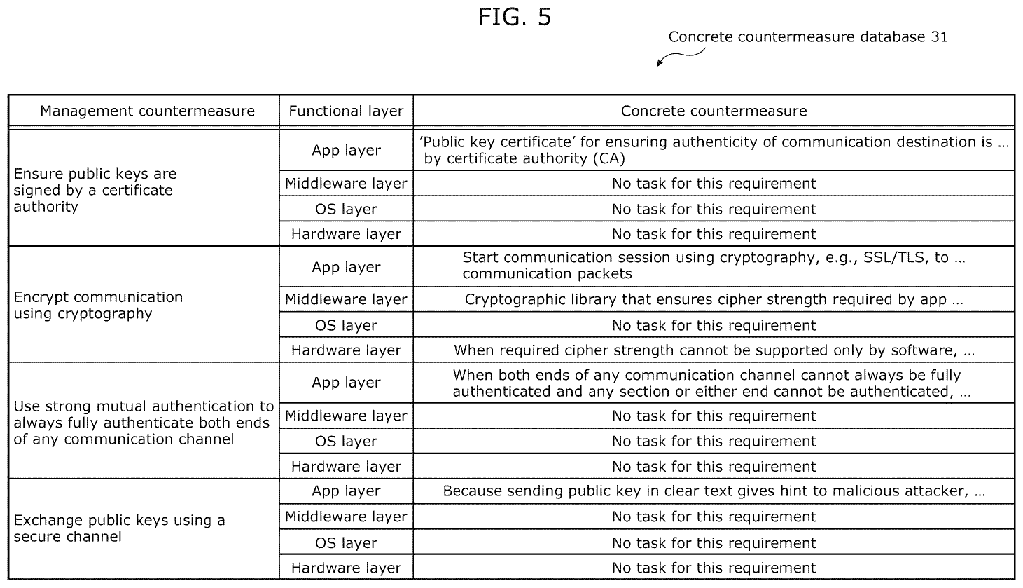

FIG. 5 is a diagram illustrating an example of the concrete countermeasure database according to the present embodiment.

Concrete countermeasure storage 30 stores concrete countermeasure database 31 as illustrated by example in FIG. 5. As illustrated in FIG. 5, concrete countermeasure database 31 shows, for each of a plurality of management countermeasures, a concrete countermeasure for each of the functional layers. To be more specific, concrete countermeasure database 31 shows, for each of the plurality of management countermeasures, a concrete countermeasure for the app layer, a concrete countermeasure for the middleware layer, a concrete countermeasure for the OS layer, and a concrete countermeasure for the hardware layer. For example, for the management countermeasure stating “Ensure public keys are signed by a certificate authority”, concrete countermeasure database 31 shows the concrete countermeasure stating “‘Public key certificate’ for ensuring the authenticity of the communication destination is . . . by certificate authority (CA)” for the app layer. Furthermore, for the aforementioned management countermeasure, concrete countermeasure database 31 shows the concrete countermeasure “No task for this requirement” for each of the middleware layer, the OS layer, and the hardware layer. This concrete countermeasure stating “No task for this requirement” means that there is no concrete countermeasure or that no concrete countermeasure is required. Note that the management countermeasures illustrated in FIG. 5 correspond to “Mitigations” of Common Attack Pattern Enumeration and Classification (CAPEC)-94, for example.

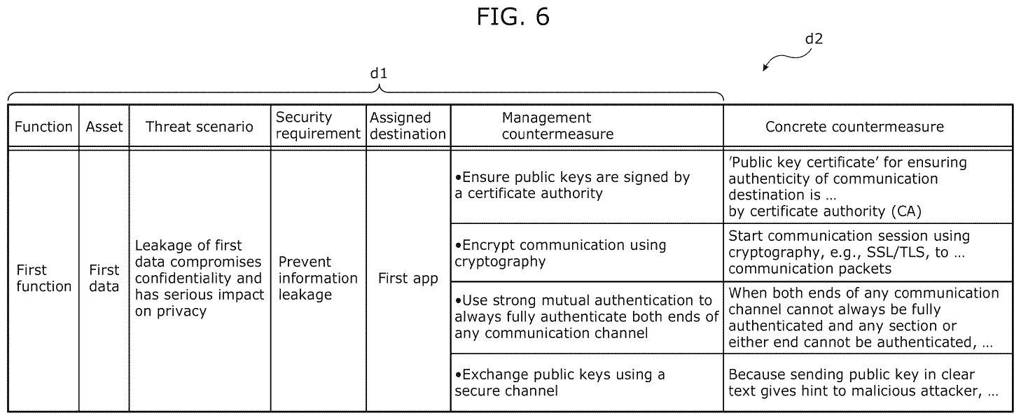

FIG. 6 is a diagram illustrating an example of part of second analysis result information d2 according to the present embodiment.

Second analysis result information d2 includes first analysis result information d1 and the concrete countermeasures combined with first analysis result information d1, as illustrated by example in FIG. 6. For example, countermeasure processor 13 obtains first analysis result information d1 from analyzer 12, and further obtains functional layer information d13 included in design information d10 from input unit 11 via analyzer 12. Next, countermeasure processor 13 determines the functional layer of the component indicated as the assigned destination in first analysis result information d1, with reference to functional layer information d13. Furthermore, countermeasure processor 13 determines, from concrete countermeasure database 31, the concrete countermeasure associated with this functional layer and with the management countermeasure indicated in first analysis result information d1. Then, countermeasure processor 13 combines the determined concrete countermeasure with first analysis result information d1 to associate this concrete countermeasure with the management countermeasure.

Specifically, first analysis result information d1 indicates component “First app” as the assigned destination. Thus, countermeasure processor 13 determines “App layer” as the functional layer of component “First app”, with reference to functional layer information d13. Next, countermeasure processor 13 determines, from concrete countermeasure database 31, the concrete countermeasure associated with functional layer “App layer” and the management countermeasure stating “Ensure public keys are signed by a certificate authority” indicated in first analysis result information d1. To be more specific, countermeasure processor 13 determines the concrete countermeasure stating “‘Public key certificate’ for ensuring the authenticity of the communication destination is . . . by certificate authority (CA)”. Then, countermeasure processor 13 combines the determined concrete countermeasure stating “‘Public key certificate’ for ensuring the authenticity of the communication destination is . . . by certificate authority (CA)” with first analysis result information d1 to associate this determined concrete countermeasure with the management countermeasure stating “Ensure public keys are signed by a certificate authority”. Such combining for a concrete countermeasure is performed for each of the management countermeasures indicated in first analysis result information d1 to associate the concrete countermeasure with the management countermeasure.

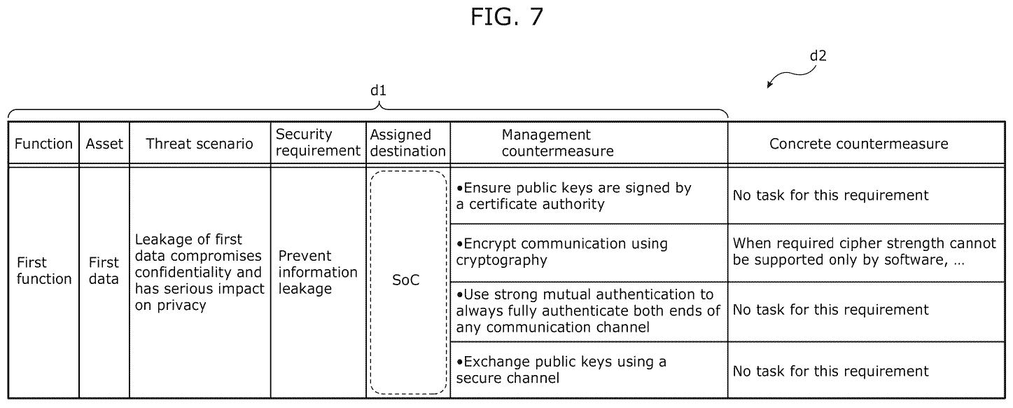

FIG. 7 is a diagram illustrating an example of different part of second analysis result information d2 according to the present embodiment.

Countermeasure processor 13 according to the present embodiment also includes, in second analysis result information d2, a concrete countermeasure associated with a functional layer of an assigned destination different from the assigned destination indicated in first analysis result information d1. For example, not only the first app but also a System on a Chip (SoC) is included as a component in a data flow of first data that is an asset indicated in first analysis result information d1. Note that the data flow of the first data is indicated by asset input-output information d15. In this case, countermeasure processor 13 creates a duplicate of first analysis result information d1 and changes the assigned destination from “First app” to “SoC”. Furthermore, countermeasure processor 13 determines “hardware layer” as the functional layer of component “SoC”, with reference to functional layer information d13. Next, countermeasure processor 13 determines, from concrete countermeasure database 31, the concrete countermeasure associated with functional layer “hardware layer” and with the management countermeasure stating “Ensure public keys are signed by a certificate authority” indicated in first analysis result information d1. To be more specific, countermeasure processor 13 determines the concrete countermeasure stating “No task for this requirement”. Then, countermeasure processor 13 combines the determined concrete countermeasure stating “No task for this requirement” with first analysis result information d1 in which the assigned destination has been changed, to associate this determined concrete countermeasure with the management countermeasure stating “Ensure public keys are signed by a certificate authority”. Such combining for a concrete countermeasure is performed for each of the management countermeasures indicated in first analysis result information d1 in which the assigned destination has been changed, to associate the concrete countermeasure with the management countermeasure.

Note that because the concrete countermeasure stating “No task for this requirement” means that there is no concrete countermeasure, the combining for the concrete countermeasure may be skipped.

Second analysis result information d2 according to the present embodiment includes the part of second analysis result information d2 illustrated in FIG. 6 and the different part of second analysis result information d2 illustrated in FIG. 7.

In the present embodiment as described above, with reference to the data flow indicated by asset input-output information d15 included in design information d10, countermeasure processor 13 determines, from among the plurality of components, one or more components in the data flow as one or more components relating to the asset. This enables an appropriate determination of the one or more components relating to the asset. As in the example illustrated in FIG. 6, the first app is determined to be the component from the data flow. Thus, in the examples illustrated in FIG. 6 and FIG. 7, the one or more components are the first app and the SoC.

Next, countermeasure processor 13 determines, among a plurality of functional layers indicated by functional layer information d13 of design information d10, one or more functional layers to which the one or more components relating to the first data as the asset belong, with reference to functional layer information d13. In the examples illustrated in FIG. 6 and FIG. 7, the one or more functional layers are the app layer and the hardware layer.

Then, countermeasure processor 13 determines the concrete countermeasures associated with the management countermeasure indicated in first analysis result information d1 and with the one or more functional layers, with reference to concrete countermeasure database 31. Following this, countermeasure processor 13 combines the determined concrete countermeasures with first analysis result information d1.

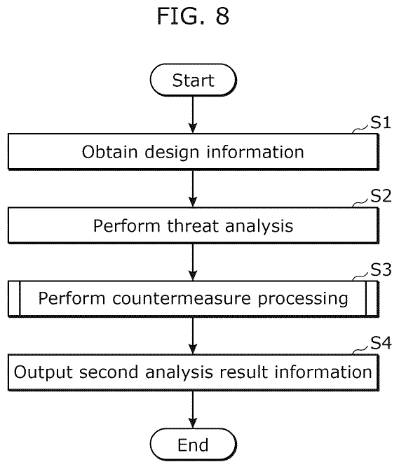

FIG. 8 is a flowchart illustrating an example of a processing operation performed by threat analysis system 10 according to the present embodiment.

Input unit 11 of threat analysis system 10 obtains design information d10 (step S1). Next, analyzer 12 generates first analysis result information d1 by performing threat analysis based on design information d10 and the threat database stored in threat storage 20 (step S2). Next, countermeasure processor 13 generates second analysis result information d2 by performing countermeasure processing based on first analysis result information d1 generated in step S2 and concrete countermeasure database 31 stored in concrete countermeasure storage 30 (step S3). Then, output unit 14 outputs second analysis result information d2 generated in step S3 to, for example, the display (step S4).

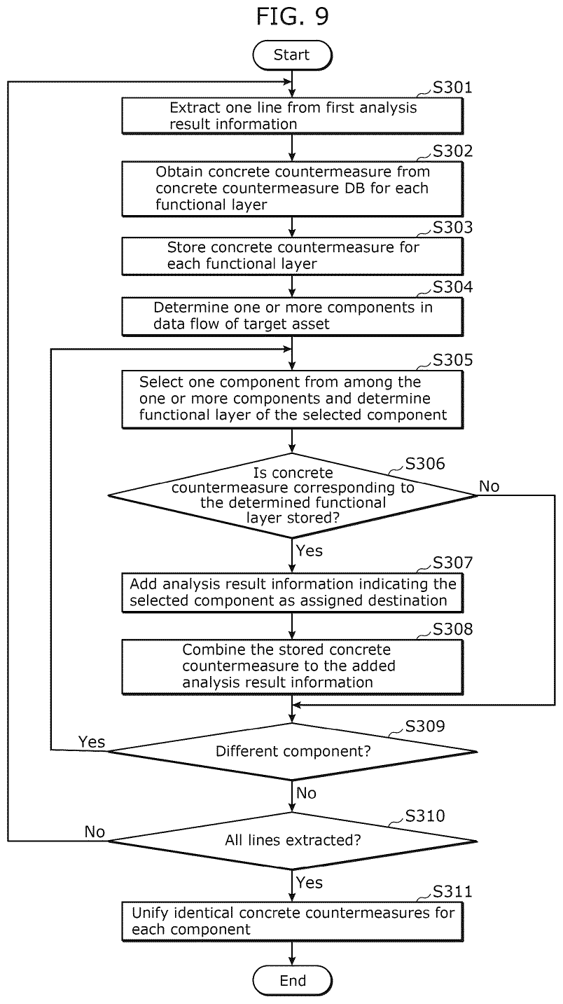

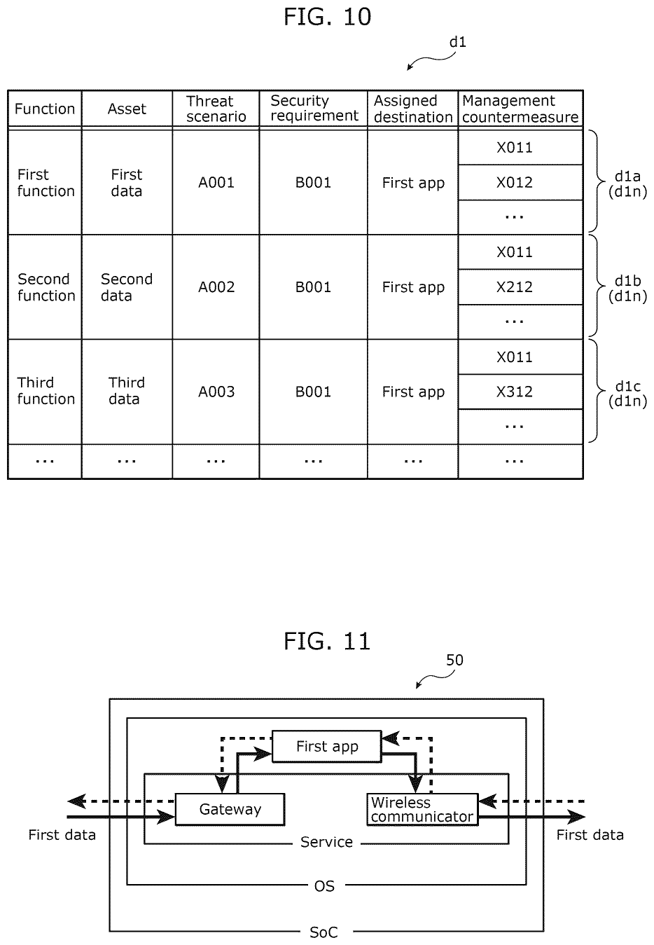

FIG. 9 is a flowchart illustrating an example of a specific processing operation of the countermeasure processing performed by threat analysis system 10 according to the present embodiment. Specifically, the flowchart in FIG. 9 illustrates in detail the countermeasure processing performed in step S3 in FIG. 8. The following describes in detail the countermeasure processing with reference to FIG. 10 to FIG. 15 in addition to FIG. 9.

In the countermeasure processing, when countermeasure processor 13 has obtained first analysis result information d1 from analyzer 12, countermeasure processor 13 extracts one line of information (that is, line information described later) from first analysis result information d1 (step S301).

FIG. 10 is a diagram illustrating an example of first analysis result information d1 that includes a plurality of sets of line information.

First analysis result information d1 includes one line of information as line information din for each combination of an asset and a threat scenario, as illustrated in FIG. 10. Specifically, line information din indicates: a combination of an asset and a threat scenario; a function that uses the asset; a security requirement corresponding to the threat scenario; an assigned destination that is a component to which the function is assigned; and one or more management countermeasures to satisfy the security requirement. Note that first analysis result information d1 in the example illustrated in FIG. 10 includes three sets of line information din including line information d1a, line information d1b, and line information d1c. Line information d1a is line information din that includes a combination of asset “First data” and threat scenario “A001”. Line information d1b is line information din that includes a combination of asset “Second data” and threat scenario “A002”. Line information d1c is line information din that includes a combination of asset “Third data” and threat scenario “A003”.

Note that “A001”, “A002”, “A003”, “B001”, “X011”, “X012”, “X212”, and “X312” in FIG. 10 represent respective sentences for simplicity. Moreover, strings starting with an alphabetical letter followed by three digits in FIG. 11 to FIG. 15 represent respective sentences for simplicity, as in FIG. 10. The example in FIG. 10 shows the three sets of line information din. However, first analysis result information d1 may include at least one set of line information din, and may include four or more sets of line information din.

For example, countermeasure processor 13 extracts line information d1a that is one line of information including the combination of asset “First data” and threat scenario “A001”, in step S301 in FIG. 9.

Next, countermeasure processor 13 obtains, for each of the one or more management countermeasures included in line information d1a, the concrete countermeasure for each of the with the management functional layers associated countermeasure, from concrete countermeasure database 31 (step S302). For example, line information d1a is obtained in step S301. In this case, countermeasure processor 13 obtains the concrete countermeasures associated with management countermeasure “X011” indicated in line information d1a and with the app layer, the middleware layer, the OS layer, and the hardware layer, from concrete countermeasure database 31. As a result, the concrete countermeasure for each of the four functional layers, that is, the four concrete countermeasures are obtained corresponding to management countermeasure “X011”. Furthermore, countermeasure processor 13 obtains the concrete countermeasures associated with management countermeasure “X012” indicated in line information d1a and with the app layer, the middleware layer, the OS layer, and the hardware layer, from concrete countermeasure database 31. As a result, the concrete countermeasure for each of the four functional layers, that is, the four concrete countermeasures are obtained corresponding to management countermeasure “X012”.

Note that the concrete countermeasure stating “No task for this requirement” in concrete countermeasure database 31 means that there is no concrete countermeasure. On this account, when this concrete countermeasure stating “No task for this requirement” is associated with the management countermeasure indicated in line information d1a and with any one of the functional layers in concrete countermeasure database 31, countermeasure processor 13 need not obtain this concrete countermeasure.

Then, countermeasure processor 13 temporarily stores the concrete countermeasures associated with the functional layers obtained in step S302 (step S303).

Next, countermeasure processor 13 determines the one or more components in the data flow of a target asset that is the asset indicated in line information din (for example, line information d1a) extracted in step S301 (step S304). This data flow is indicated by asset input-output information d15.

FIG. 11 is a diagram illustrating an example of asset input-output information d15.

For example, analysis target system 50 includes the SoC, the OS, a service, a gateway, a wireless communicator, and the first app as components, as illustrated in FIG. 11. Note that the wireless communicator is a component that performs wireless communications based on, for example, Wi-Fi (registered trademark). Asset input-output information d15 indicates the data flow for each asset in analysis target system 50 having the configuration as described above. For example, when line information din extracted in step S301 is line information d1a, the target asset is the first data. In the data flow of the first data, the first data is inputted from the SoC to the first app via the OS, the service, and the gateway, and then outputted from the first app to the outside of analysis target system 50 via the wireless communicator, the service, the OS, and the SoC, as indicated by the solid arrows by example in FIG. 11. Specifically, the SoC, the OS, the service, the gateway, the first app, and the wireless communicator are the components in the data flow of the first data.

In step S304 in FIG. 9, when the target asset is the first data, countermeasure processor 13 determines the SoC, the OS, the service, the gateway, the first app, and the wireless communicator to be the components in the data flow of the first data.

Then, countermeasure processor 13 selects one component from among the one or more components determined in step S304, and determines the functional layer of this component with reference to functional layer information d13 (step S305). To repeat the process of step S305, countermeasure processor 13 selects the components in the data flow of the target asset in reverse order of the data flow. Note that the reverse order of the data flow is from downstream to upstream in the data flow, as indicated by the broken arrows in FIG. 11. In the process of step S305 for a first time around, the farthest downstream component in the data flow is selected. For example, when the target asset is the first data and the data flow of the first data is as indicated by the solid arrows in FIG. 11, countermeasure processor 13 selects component “SoC” that is the farthest downstream component in the data flow. Then, countermeasure processor 13 determines “hardware component” to be the functional layer of component “SoC”, with reference to functional layer information d13.

Next, countermeasure processor 13 determines whether a concrete countermeasure associated with the functional layer determined in step S305 has been stored in step S303 (step S306). For example, in step S303, the concrete countermeasure associated with management countermeasure “X011” and the app layer, the concrete countermeasure associated with management countermeasure “X011” and the middleware layer, the concrete countermeasure associated with management countermeasure “X011” and the OS layer, and the concrete countermeasure associated with management countermeasure “X011” and the hardware layer are stored, for example.

Furthermore, in step S303, the concrete countermeasure associated with management countermeasure “X012” and the app layer, the concrete countermeasure associated with management countermeasure “X012” and the middleware layer, the concrete countermeasure associated with management countermeasure “X012” and the OS layer, and the concrete countermeasure associated with management countermeasure “X012” and the hardware layer are stored. In step S305, “hardware component” is determined to be the functional layer, for example.

In this case, the concrete countermeasure associated with management countermeasure “X011” and the hardware layer and the concrete countermeasure associated with management countermeasure “X012” and the hardware layer, out of the plurality of management countermeasures stored in step S303, are associated with “hardware layer” determined to be the functional layer in step S305. Thus, countermeasure processor 13 determines in step S306 that the concrete countermeasures associated with the functional layer determined in step S305 have been stored in step S303 (Yes in step S306).

Next, when the aforementioned concrete countermeasures are determined to be stored (Yes in step S306), countermeasure processor 13 adds, to line information din extracted in step S301, analysis result information that indicates the component selected in step S305 as the assigned destination (step S307). This analysis result information and line information din are different only in the assigned destination. Furthermore, countermeasure processor 13 combines a concrete countermeasure group with the added analysis result information, the concrete countermeasure group including one or more concrete countermeasures associated with the functional layer determined in step S305, out of the plurality of concrete countermeasures stored in step S303 (step S308). For example, when line information d1a illustrated in FIG. 10 is extracted in step S301, part relating to line information d1a of second analysis result information d2 includes: line information d1a; the analysis result information added to line information d1a; and the concrete countermeasure group combined with the analysis result information.

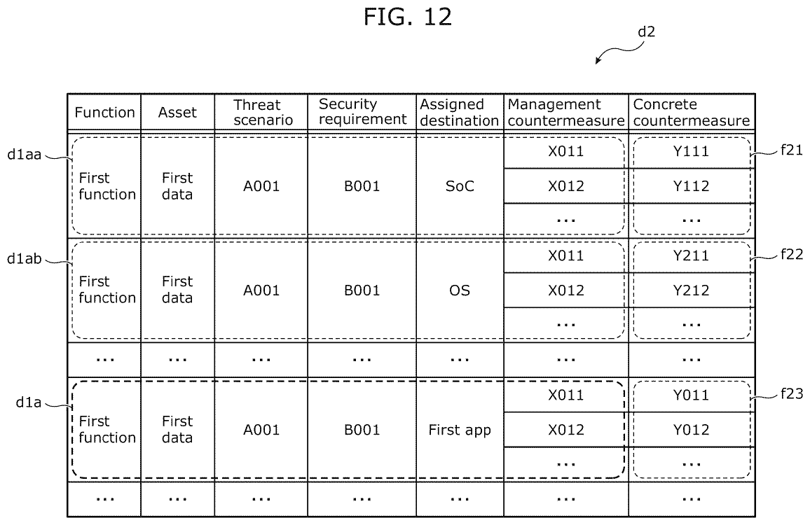

FIG. 12 is a diagram illustrating an example of the part relating to line information d1a included in second analysis result information d2.

In step S307, countermeasure processor 13 adds analysis result information d1aa to line information d1a, as illustrated by example in FIG. 12. Analysis result information d1aa and line information d1a are different only in the assigned destination. Analysis result information d1aa indicates, for example, component “SoC” selected in step S305, as the assigned destination.

In step S308, countermeasure processor 13 adds concrete countermeasure group f21 to analysis result information d1aa that has been added, as illustrated by example in FIG. 12. Concrete countermeasure group f21 includes the one or more concrete countermeasures associated with “hardware layer” determined to be the functional layer of component “SoC” in step S305, out of the plurality of concrete countermeasures stored in step S303. The one or more concrete countermeasures are “Y111” and “Y112”, for example. Concrete countermeasure “Y111” is associated with “hardware layer” as the functional layer of component “SoC” that is the assigned destination and with management countermeasure “X011”. Concrete countermeasure “Y112” is associated with “hardware layer” as the functional layer of component “SoC” that is the assigned destination and with management countermeasure “X012”.

Next, countermeasure processor 13 determines whether the one or more components determined in step S304 include another component as a different component that has not been selected in step S305 (step S309). When the different component is determined to be included (Yes in step S309), countermeasure processor 13 performs the processes from step S305 again. For example, in the data flow of the first data illustrated in FIG. 11, component “SoC” is followed by component “OS” in the reverse order of the data flow. Thus, when component “SoC” has been selected in step S305 most recently performed, countermeasure processor 13 determines component “OS” to be the different component (Yes in step S309). As a result, in step S305 that follows, countermeasure processor 13 selects component “OS” and determines the OS layer to be the functional layer of component “OS”. Then, countermeasure processor 13 performs steps S306 to S308 again. Thus, countermeasure processor 13 adds analysis result information d1ab to line information d1a of first analysis result information d1, and adds concrete countermeasure group f22 to analysis result information d1ab that has been added, as illustrated in FIG. 12.

Analysis result information d1ab and line information d1a are different only in the assigned destination. Analysis result information d1ab indicates component “OS” selected in step S305, as the assigned destination.

Concrete countermeasure group f22 includes the one or more concrete countermeasures associated with “OS layer” determined to be the functional layer of component “OS” in step S305, out of the plurality of concrete countermeasures stored in step S303. The one or more concrete countermeasures are “Y211” and “Y212”, for example. Concrete countermeasure “Y211” is associated with “OS layer” as the functional layer of component “OS” that is the assigned destination and with management countermeasure “X011”. Concrete countermeasure “Y212” is associated with “OS layer” as the functional layer of component “OS” that is the assigned destination and with management countermeasure “X012”.

Because steps S305 to S309 are repeated, component “first app” indicated as the assigned destination in line information d1a may be selected in step S305. In this case, countermeasure processor 13 skips step S307 and combines concrete countermeasure group f23 with line information d1a (step S308).

Concrete countermeasure group f23 includes the one or more concrete countermeasures associated with “app layer” determined to be the functional layer of component “first app”, out of the plurality of concrete countermeasures stored in step S303. The one or more concrete countermeasures are “Y011” and “Y012”, for example. Concrete countermeasure “Y011” is associated with “app layer” as the functional layer of component “first app” that is the assigned destination and with management countermeasure “X011”. Concrete countermeasure “Y012” is associated with “app layer” as the functional layer of component “first app” that is the assigned destination and with management countermeasure “X012”.

By the repetitions of steps S305 to S309 as described above, the part relating to line information d1a included in second analysis result information d2 is generated as illustrated by example in FIG. 12.

According to the present embodiment, countermeasure processor 13 selects one component as a processing target component from among the one or more components in the data flow of the target asset (that is, the first data in the above example), in the reverse order of the data flow. In step S305 in the above example, the SoC, the OS, . . . and the first app are selected in this order, each being the processing target component. Then, whenever countermeasure processor 13 has selected the processing target component, countermeasure processor 13 determines the concrete countermeasures associated with the management countermeasure indicated in first analysis result information d1 and with the functional layer of this processing target component, with reference to concrete countermeasure database 31. In the above example, the determined concrete countermeasures are “Y111”, “Y112”, “Y211”, “Y212”, “Y011”, and “Y012”. In this way, the one or more components relating to the asset are determined in an appropriate order and the concrete countermeasures are determined in this appropriate order.

Note that when countermeasure processor 13 has determined in step S306 that the concrete countermeasure associated with the functional layer determined in step S305 has not been stored in step S303 (No in step S306), countermeasure processor 13 skips steps S307 and S308.

Next, when countermeasure processor 13 has determined that a different component is not included (No in step S309), countermeasure processor 13 determines whether all lines included in first analysis result information d1, that is, all sets of line information din have been extracted (step S310). For example, when, out of the three sets of line information din, only line information d1a has been extracted and line information d1b and line information d1c have not been extracted, countermeasure processor 13 determines that not all of the sets of line information din have been extracted (No in step S310). In this case, countermeasure processor 13 performs the processes from step S301 again. For example, in step S301, countermeasure processor 13 extracts line information d1b from first analysis result information d1. Then, based on line information d1b, countermeasure processor 13 generates part relating to line information d1b included in second analysis result information d2.

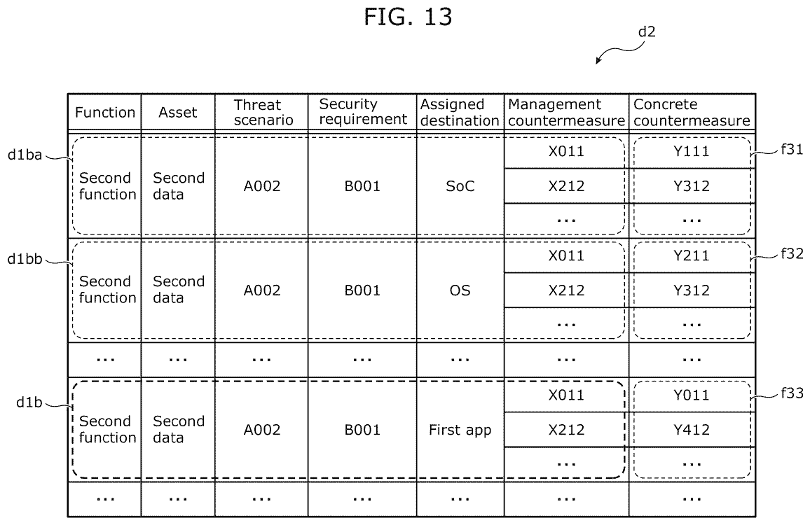

FIG. 13 is a diagram illustrating an example of part relating to line information d1b included in second analysis result information d2.

When line information d1b has been extracted from first analysis result information d1 in step S301, countermeasure processor 13 executes steps S302 to S309 as above. As a result of executing steps S305 to S309 for a first time around, countermeasure processor 13 adds analysis result information d1ba to line information d1b and adds concrete countermeasure group f31 to analysis result information d1ba that has been added, as illustrated in FIG. 13.

Analysis result information d1ba and line information d1b are different only in the assigned destination. Analysis result information d1ba indicates component “SoC” selected in step S305, as the assigned destination.

Concrete countermeasure group f31 includes the one or more concrete countermeasures associated with “hardware layer” determined to be the functional layer of component “SoC”. The one or more concrete countermeasures are “Y111” and “Y312”, for example. Concrete countermeasure “Y111” is associated with “hardware layer” as the functional layer of component “SoC” that is the assigned destination and with management countermeasure “X011”. Concrete countermeasure “Y312” is associated with “hardware layer” as the functional layer of component “SoC” that is the assigned destination and with management countermeasure “X212”.

Next, by executing steps S305 to S309 for a second time around, countermeasure processor 13 adds analysis result information d1bb to line information d1b and adds concrete countermeasure group f32 to analysis result information d1bb that has been added, as illustrated in FIG. 13.

Analysis result information d1bb and line information d1b are different only in the assigned destination. Analysis result information d1bb indicates component “OS” selected in step S305, as the assigned destination.

Concrete countermeasure group f32 includes the one or more concrete countermeasures associated with “OS layer” determined to be the functional layer of component “OS”. The one or more concrete countermeasures are “Y211” and “Y312”, for example. Concrete countermeasure “Y211” is associated with “OS layer” as the functional layer of component “OS” that is the assigned destination and with management countermeasure “X011”. Concrete countermeasure “Y312” is associated with “OS layer” as the functional layer of component “OS” that is the assigned destination and with management countermeasure “X212”.

Furthermore, by the execution of steps S305 to S309 for an n-th time around (where n is an integer greater than or equal to 3), component “first app” indicated as the assigned destination in line information d1b is selected in step S305. In this case, countermeasure processor 13 skips step S307 and combines concrete e countermeasure group f33 with line information d1b as illustrated in FIG. 13.

Concrete countermeasure group f33 includes the one or more concrete countermeasures associated with “app layer” determined to be the functional layer of component “first app”. The one or more concrete countermeasures are “Y011” and “Y412”, for example. Concrete countermeasure “Y011” is associated with “app layer” as the functional layer of component “first app” that is the assigned destination and with management countermeasure “X011”. Concrete countermeasure “Y412” is associated with “app layer” as the functional layer of component “first app” that is the assigned destination and with management countermeasure “X212”.

Next, when countermeasure processor 13 has determined that a different component is not included (No in step S309), countermeasure processor 13 determines whether all lines included in first analysis result information d1, that is, all sets of line information din have been extracted (step S310). For example, when, out of the three sets of line information din, line information d1a and line information d1b have been extracted and line information d1c has not been extracted, countermeasure processor 13 determines that not all of the sets of line information din have been extracted (No in step S310). In this case, countermeasure processor 13 performs the processes from step S301 again. For example, in step S301, countermeasure processor 13 extracts line information d1c from first analysis result information d1. Then, based on line information d1c, countermeasure processor 13 generates part relating to line information d1c included in second analysis result information d2.

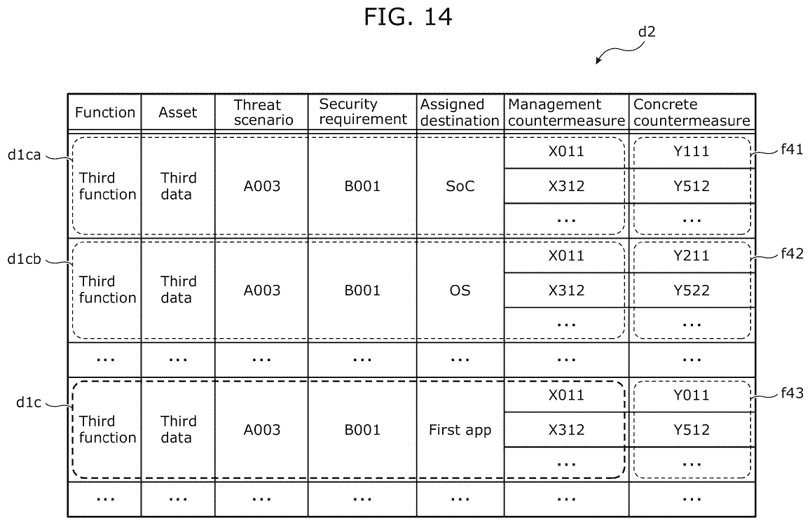

FIG. 14 is a diagram illustrating an example of part relating to line information d1c included in second analysis result information d2.

As in the example illustrated in FIG. 13, by executing steps S302 to S309, countermeasure processor 13 adds analysis result information d1ca and analysis result information d1cb to line information d1c as illustrated in FIG. 14. Furthermore, countermeasure processor 13 adds concrete countermeasure group f41 to analysis result information d1ca, adds concrete countermeasure group f42 to analysis result information d1cb, and adds concrete countermeasure group f43 to line information d1c. As a result, the part relating to line information d1c of second analysis result information d2 is generated.

Next, when countermeasure processor 13 has determined that a different component is not included (No in step S309), countermeasure processor 13 determines whether all lines included in first analysis result information d1, that is, all sets of line information din have been extracted (step S310). For example, when, out of the three sets of line information din, line information d1a, line information d1b, and line information d1c have been extracted, countermeasure processor 13 determines that all the sets of line information din have been extracted (Yes in step S310). In this case, countermeasure processor 13 lists, for each of the components indicated as the assigned destinations in second analysis result information d2, the one or more concrete countermeasures associated with the component. Then, when the one or more concrete countermeasures include a plurality of identical concrete countermeasures, countermeasure processor 13 unifies the plurality of identical concrete countermeasures (step S311). Specifically, countermeasure processor 13 edits second analysis result information d2 by unifying the plurality of identical concrete countermeasures into one concrete countermeasure for each of the components. In this case, countermeasure processor 13 may edit second analysis result information d2 to indicate, for each of the plurality of components and for each security requirement, the one or more concrete countermeasures associated with the component and the security requirement.

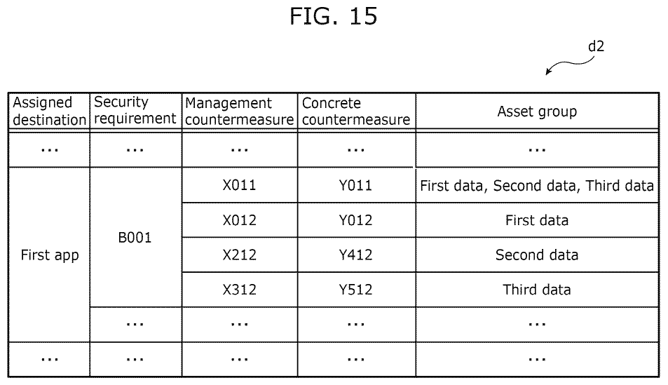

FIG. 15 is a diagram illustrating an example of second analysis result information d2 after an edit.

As illustrated by example in FIG. 15, second analysis result information d2 after the edit indicates one or more security requirements for component “first app” that is the assigned destination. Each of the one or more security requirements is associated with component “first app” indicated as the assigned destination in second analysis result information d2 before the edit. The example in FIG. 15 illustrates security requirement “B001” that is associated with component “first app”.

Furthermore, second analysis result information d2 after the edit indicates one or more pairs of management countermeasure and concrete countermeasure associated with security requirement “B001”. Each of the one or more pairs of management countermeasure and concrete countermeasure is associated with component “first app” and security requirement “B001” in second analysis result information d2 before the edit.

In the example in FIG. 15, the one or more pairs of countermeasures include a first pair of management countermeasure “X011” and concrete countermeasure “Y011” and a second pair of management countermeasure “X012” and concrete countermeasure “Y012”.

Furthermore, second analysis result information d2 after the edit indicates an asset group including one or more assets, for each of the one or more pairs of countermeasures. The asset group associated with the pair of countermeasures includes the one or more assets that are associated with component “first app”, security requirement “B001”, and this pair of countermeasures in second analysis result information d2 before the edit. In the example in FIG. 15, the asset group associated with the first pair of countermeasures, that is, the pair of management countermeasure “X011” and concrete countermeasure “Y011” includes the first data, the second data, and the third data.

Specifically, as illustrated in FIG. 12 to FIG. 14, second analysis result information d2 before the edit indicates management countermeasure “X011” and concrete countermeasure “Y011” as the pair of countermeasures associated with component “first app”, individually for each of the assets, i.e., the first data, the second data, and the third data. In contrast, second analysis result information d2 after the edit indicates only one pair of countermeasures, that is, the pair of management countermeasure “X011” and concrete countermeasure “Y011”, associated with component “first app”. Specifically, the identical pairs of countermeasures are unified into one pair of countermeasures.

In this way, countermeasure processor 13 edits second analysis result information d2 to indicate, for each of the components and for each of the security requirements, the one or more pairs of countermeasures associated with the component and the security requirement. Furthermore, when there are identical pairs of countermeasures associated with the component and the security requirement, countermeasure processor 13 edits second analysis result information d2 by unifying these identical pairs of countermeasures into one pair of countermeasures.

Note that second analysis result information d2 after the edit and second analysis result information d2 before the edit may differ only in structure, and may have the same substantial content.

Output unit 14 outputs second analysis result information d2 after the edit to the display. Specifically, output unit 14 displays second analysis result information d2 after the edit on the display. In this case, output unit 14 may display the content indicated by second analysis result information d2 after the edit in stages, based on an input operation of the user.

For example, output unit 14 displays, on the display, names of the plurality of components indicated as the assigned destinations in second analysis result information d2 after the edit. Then, when the name of one component has been selected through an input operation of the user, output unit 14 displays, on the display, the one or more security requirements associated with this component in second analysis result information d2 after the edit. Furthermore, when one of the security requirements has been selected through an input operation of the user, output unit 14 displays, on the display, the one or more pairs of countermeasures associated with this security requirement in second analysis result information d2 after the edit. Output unit 14 may display the one or more pairs of countermeasures one by one, on the display. When displaying the pair of countermeasures, output unit 14 may also display, on the display, names of the assets included in the asset group associated with this pair of countermeasures in second analysis result information d2 after the edit.

For example, when displaying the pair of management countermeasure “X011” and concrete countermeasure “Y011” on the display, output unit 14 may also display, on the display, the names of the first data, the second data, and the third data included in the asset group associated with this pair of countermeasures.

In this way, when output unit 14 according to the present embodiment outputs second analysis result information d2, output unit 14 outputs one or more concrete countermeasures that are indicated in second analysis result information d2 for each component included in analysis target system 50 and that are associated with a functional layer of the component. Then, when second analysis result information d2 indicates a plurality of concrete countermeasures associated with the functional layer of the component and the plurality of concrete countermeasures include a plurality of identical concrete countermeasures, output unit 14 outputs only one concrete countermeasure as a unified concrete countermeasure from among the plurality of identical concrete countermeasures. Note that the plurality of identical concrete countermeasures are included in each of the plurality of identical pairs of countermeasures described above.

In this way, for each component, the one or more concrete countermeasures associated with the functional layer of the component are outputted (e.g., displayed). This allows the development person responsible for the functional layer can easily identify the one or more concrete countermeasures required for the component belonging to this functional layer. Moreover, only one of the plurality of identical concrete countermeasures is outputted (e.g., displayed) as the unified concrete countermeasure. In other words, the plurality of identical concrete countermeasures are unified into one concrete countermeasure. This can reduce the number of concrete countermeasures to be displayed. Thus, the development person can reduce a burden of checking concrete countermeasures to be executed by this development person, and thus can easily identify the concrete countermeasure.

Furthermore, when the plurality of identical concrete countermeasures are associated with respective different assets, output unit 14 according to the present embodiment outputs information indicating the respective different assets in association with the unified concrete countermeasure. In the example described above, the names of the first, second, and third data are outputted and displayed on the display, as the information indicating the respective different assets.

In this way, even when the plurality of identical concrete countermeasures are unified into one concrete countermeasure, this unified concrete countermeasure is outputted (e.g., displayed) in association with the information indicating the different assets. This allows the development person to easily identify the association between this unified concrete countermeasure and the assets.

According to the present embodiment described above, second analysis result information d2 including first analysis result information d1 and the concrete countermeasure is outputted. Specifically, not only the management countermeasure but also the concrete countermeasure that is concretized from this management countermeasure and that is associated with the corresponding one of the one or more functional layers is outputted and displayed on, for example, a display. This allows, for example, a development person responsible for the functional layer to easily identify the concrete countermeasure associated with the functional layer this development person is responsible for, among the concrete countermeasures against the threat to analysis target system 50.

According to the present embodiment, an appropriate countermeasure against the threat can be presented. This allows the development person responsible for the functional layer to appropriately perform the concrete countermeasure on the component belonging to this functional layer in analysis target system 50. Thus, even when the development person is not a security person, the development person can easily understand the concrete countermeasure and immediately execute this concrete countermeasure. This increases the efficiency of security activities and enhances the quality of security.

According to the present embodiment, concrete countermeasure database 31 stores beforehand, for each of the plurality of management countermeasures, the concrete countermeasure for each functional layer. Thus, with reference to concrete countermeasure database 31, an appropriate concrete countermeasure can be determined and combined with first analysis result information d1.

According to the present embodiment, functional layer information d13 of design information d10 includes beforehand the functional layer for each of the plurality of components. Thus, with reference to functional layer information d13, an appropriate functional layer can be determined. This prevent a functional layer of a component unrelated to the asset handled by analysis target system 50 from being determined. Thus, only the required concrete countermeasure associated with the functional layer can be presented.

### OTHER EMBODIMENTS

Although the thread analysis system and the thread analysis method according to one or more aspects of the present disclosure have been described based on an embodiment, the present disclosure is not limited to this embodiment. Those skilled in the art will readily appreciate that embodiments arrived at by making various modifications to the above embodiment without materially departing from the scope of the present disclosure may be included within one or more aspects of the present disclosure.

For example, based on an operation performed on a zoom button by the user, output unit 14 may display, on the display, only the one or more concrete countermeasures associated with the functional layer in second analysis result information d2.

When displaying, for each component, the one or more concrete countermeasures associated with the functional layer of the component on the display as described above, output unit 14 may also display on the display whether there are concrete countermeasures associated with the functional layer of a different component other than the present component. Output unit 14 may also display the concrete countermeasures associated with the functional layer of the aforementioned different component on the display. Output unit 14 may determine, based on information indicating a functional layer for which a development person is responsible, whether the functional layer associated with the concrete countermeasures displayed on the display is the functional layer for which the development person is responsible. Then, output unit 14 may display a result of the determination on the display.

In the embodiment described above, the number of functional layers are four. When each of one or more functional layers is defined, the number of functional layers may be any number. Moreover, the one or more functional layers that are defined may be a plurality of functional layers freely set by the user, or may be a plurality of functional layers based on the Open Systems Interconnection (OSI) reference model.

In the embodiment described above, the four functional layers indicated in functional layer information d13 are in a one-to-one association with the four functional layers indicated in concrete countermeasure database 31. However, the plurality of functional layers indicated in functional layer information d13 need not be in a one-to-one association with the plurality of functional layers indicated in concrete countermeasure database 31 when the plurality of functional layers indicated in functional layer information d13 and the plurality of functional layers indicated in concrete countermeasure database 31 are associated according to a predetermined rule. In other words, the functional layers indicated in functional layer information d13 and the functional layers indicated in concrete countermeasure database 31 may differ in resolution.

For example, the number of functional layers indicated in functional layer information d13 may be three whereas the of functional layers indicated number in concrete countermeasure database 31 may be four. As a specific example, the three functional layers indicated in functional layer information d13 are A, B, and C.

The four functional indicated in concrete countermeasure database 31 are a, b, c, and d. In this case, functional layer “A” may correspond to, for example, functional layer “a” and thus may be handled as functional layer “a”. Functional layer “B” may correspond to, for example, functional layers “b” and “c” and thus may be handled as functional layers “b” and “c”. Functional layer “C” may correspond to, for example, functional layer “d” and thus may be handled as functional layer “d”. In this way, the plurality of functional layers indicated in functional layer information d13 need not be in a one-to-one association with the plurality of functional layers indicated in concrete countermeasure database 31 when the plurality of functional layers indicated in functional layer information d13 and the plurality of functional layers indicated in concrete countermeasure database 31 are in a predetermined association.

Note that the association between the plurality of functional layers indicated in functional layer information d13 and the plurality of functional layers indicated in concrete countermeasure database 31 may be established by artificial intelligence (AI).

When analysis target system 50 includes a plurality of devices as illustrated by example in FIG. 4, output unit 14 may select one device from among the plurality of devices based on an operation of the user and display, on the display, only the concrete countermeasures associated with this device.

In the embodiment described above, concrete countermeasure storage 30 stores one concrete countermeasure database 31. However, concrete countermeasure storage 30 may store a plurality of concrete countermeasure databases 31. In this case, countermeasure processor 13 may select one concrete countermeasure database 31 from among the plurality of concrete countermeasure databases 31, based on, for example, a threat scenario. For example, countermeasure processor 13 selects concrete countermeasure database 31, based on a communication system, a memory system, or an architecture system. Then, countermeasure processor 13 generates second analysis result information d2 using concrete countermeasure database 31 selected. Note that two or more concrete countermeasure databases 31 may be selected.

Concrete countermeasure storage 30 may be connected to threat analysis system 10 via a communication line, such as the Internet, and may be included in, for example, a cloud server. In the embodiment described above, countermeasure processor 13 determines, in step S306 in FIG. 9, whether the concrete countermeasure associated with the functional layer of the selected component has been stored. In this case, countermeasure processor 13 may use AI to determine whether the stored concrete countermeasure is associated with the functional layer of the component.

For example, a concrete countermeasure for an operational environment may be registered in concrete countermeasure database 31. The operational environment includes vehicle functions, production facilities, services, and repairs that are required to operate the components. More specifically, concrete countermeasure database 31 stores a management countermeasure for the operational environment associated with an “operational environmental layer” as the functional layer.

Countermeasure processor 13 adds an operational environment component defined to belong to the operational environmental layer in functional layer information d13, to the one or more components determined in step S304 in FIG. 9. After this, by the executions of S305 step to S309, the concrete countermeasure for the operational environment is made associated with first analysis result information d1.

Each of the constituent elements in each of the above embodiments may be implemented to an exclusive hardware product, or may be realized by executing a software program suitable for the element. Each of the elements may be realized by means of a program executing unit, such as a Central Processing Unit (CPU) or a processor, reading and executing the software program recorded on a recording medium such as a hard disk or semiconductor memory. Here, software implementing the thread analysis system or the like according to the above-described embodiments and variations is a program for causing a computer to execute the steps included in the flowcharts shown in FIGS. 8 and 9.

It should be noted that the present disclosure may also include the following embodiments.
(1) Each of one or more systems or devices described above may specifically be a computer system including, for example, a microprocessor, ROM (Read Only Memory), and RAM (Random Access Memory), a hard disk unit, a display unit, a keyboard, a mouse, and the like. The RAM or the hard disk unit holds a computer program. The microprocessor operates according to the computer program to cause each of the one or more devices described above to execute its function. Here, the computer program includes combinations of instruction codes for issuing instructions to the computer to execute predetermined functions.
(2) At least one of constituent elements in each of the one or more systems and devices described above may be implemented into a single Large Scale Integration (LSI). The system LSI is a multi-functional LSI in which a plurality of elements are integrated into a single chip. An example of such a system LSI is a computer system including a microprocessor, a ROM, a Random Access Memory (RAM), and the like. The ROM stores a computer program. The microprocessor operates according to the computer program to cause the system LSI to execute its function.
(3) At least one of the constituent elements included in each of the one or more systems and devices described above may be implemented into an Integrated Circuit (IC) card or a single module which is attachable to and removable from the device. The IC card or the module is a computer system including a microprocessor, a ROM, a RAM, and the like. The IC card or the module may include the above-described super multi-function LSI. The microprocessor operates according to the computer program to cause the IC card or the module to execute its functions. The IC card or the module may have tamper resistance.
(4) The present disclosure may be the above-described methods. These methods may be a computer program executed by a computer, or digital signals forming the computer program. The present disclosure may be a computer-readable recording medium on which the computer program or the digital signals are recorded. Examples of the computer-readable recording medium are a flexible disk, a hard disk, a Compact Disc-Read Only Memory (CD-ROM), a magnetooptic disk (MO), a Digital Versatile Disc (DVD), a DVD-ROM, a DVD-RAM, a BD (Blu-ray (registered trademark) Disc), and a semiconductor memory. The present disclosure may be the digital signals recorded on the recording medium.

The present disclosure may be implemented by transmitting the computer program or the digital signals via an electric communication line, a wired or wireless communication line, a network represented by the Internet, data broadcasting, and the like.

It is also possible that the program or the digital signals may be recorded onto the recording medium to be transferred, or may be transmitted via a network or the like, so that the program or the digital signals can be executed by a different independent computer system.

### FURTHER INFORMATION ABOUT TECHNICAL BACKGROUND TO THIS APPLICATION

The disclosure of the following patent application including specification, drawings, and claims is incorporated herein by reference in their entirety: Japanese Patent Application No. 2024-118957 filed on Jul. 24, 2024.

### INDUSTRIAL APPLICABILITY

The threat analysis system according to the present disclosure is applicable to a device or a system that analyzes a threat to a system included in, for example, a vehicle.

1. A threat analysis system that analyzes a security threat to an analysis target system, the threat analysis system comprising:
a memory;
a processor connected to the memory,
wherein, using the memory, the processor:
obtains design information on design of the analysis target system;
analyzes a threat to the analysis target system based on the design information to output first analysis result information, the first analysis result information indicating: an asset handled by the analysis target system; a threat to the asset; and a management countermeasure that is a countermeasure against the threat to the asset;
generates second analysis result information including the first analysis result information and one or more concrete countermeasures by combining the one or more concrete countermeasures with the first analysis result information, the one or more concrete countermeasures being concretized from the management countermeasure indicated in the first analysis result information, the one or more concrete countermeasures each being associated with a corresponding one of one or more functional layers included in the analysis target system; and
outputs the second analysis result information.

2. The threat analysis system according to claim 1,
wherein when the processor combines the one or more concrete countermeasures with the first analysis result information,
the processor:
determines, with reference to a concrete concrete countermeasure database, the one or more countermeasures each of which is associated with the management countermeasure indicated in the first analysis result information and associated with the corresponding one of the one or more functional layers, the concrete countermeasure database indicating, for each of a plurality of management countermeasures, a concrete countermeasure for each of functional layers; and
combines the one or more concrete countermeasures determined in the determining with the first analysis result information.

3. The threat analysis system according to claim 2,
wherein the design information indicates, for each of a plurality of components included in the analysis target system, a functional layer to which the component belongs, and
when the processor combines the one or more concrete countermeasures with the first analysis result information,
the processor determines, from among a plurality of functional layers indicated in the design information, the one or more functional layers to which one or more components relating to the asset belongs, with reference to the design information, the plurality of functional layers each being the functional layer.

4. The threat analysis system according to claim 3,
wherein the design information further indicates a data flow of input and output of the asset between the plurality of components, and
when the processor combines the one or more concrete countermeasures with the first analysis result information,
the processor determines, from among the plurality of components, one or more components in the data flow as the one or more components relating to the asset, with reference to the data flow indicated by the design information.

5. The threat analysis system according to claim 4,
wherein when the processor combines the one or more concrete countermeasures with the first analysis result information,
the processor selects one component as a processing target component from among the one or more components in the data flow, in a reverse order of the data flow, and
each time the processor selects the processing target component, the processor determines, with reference to the concrete countermeasure database, a concrete countermeasure among the one or more concrete countermeasures, the concrete countermeasure being associated with the management countermeasure indicated in the first analysis result information and being associated with a functional layer corresponding to the processing target component among the one or more functional layers.

6. The threat analysis system according to claim 1,
wherein when the processor outputs the second analysis result information,
the processor outputs, for each component included in the analysis target system, at least one concrete countermeasure among the one or more concrete countermeasures, the at least one concrete countermeasure being indicated in the second analysis result information and being associated with a functional layer corresponding to the component among the one or more functional layers, and
when the at least one concrete countermeasure is a plurality of concrete countermeasures, and the plurality of concrete countermeasures include identical concrete countermeasures,
the processor outputs only one concrete countermeasure as a unified concrete countermeasure from among the identical concrete countermeasures.

7. The threat analysis system according to claim 6,
wherein when the identical concrete countermeasures are associated with respective different assets,
the processor outputs information indicating the respective different assets in association with the unified concrete countermeasure.

8. A threat analysis method to be executed by a computer to analyze a security threat to an analysis target system, the threat analysis method comprising:
obtaining design information on design of the analysis target system;
analyzing a threat to the analysis target system based on the design information to output first analysis result information, the first analysis result information indicating: an asset handled by the analysis target system; a threat to the asset; and a management countermeasure that is a countermeasure against the threat to the asset;
generating second analysis result information including the first analysis result information and one or more concrete countermeasures by combining the one or more concrete countermeasures with the first analysis result information, the one or more concrete countermeasures being concretized from the management countermeasure indicated in the first analysis result information, the one or more concrete countermeasures each being associated with a corresponding one of one or more functional layers included in the analysis target system; and
outputting the second analysis result information.
